(19) United States
(12) Patent Application Publication
(10) Pub. No.: US 2009/0289215 A1
(43) Pub. Date: Nov. 26, 2009

(54) ANTIFREEZE COOLANT COMPOSITION HAVING HIGH HEAT-OXIDATION RESISTANCE

(75) Inventor: Dae Yun Bae, Gyeonggi-do (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR)

(21) Appl. No.: 12/277,950

(22) Filed: Nov. 25, 2008

(30) Foreign Application Priority Data
May 26, 2008 (KR) 10-2008-0048814

(51) Int. Cl. C09K 5/10

(52) U.S. Cl. 252/78.5; 252/78.1

(57) ABSTRACT

The present invention relates to an antifreeze coolant composition, and particularly to an antifreeze coolant composition comprising mercaptobenzothiazole as a heat-oxidation resistant agent, alkylbenzoate as a heat-oxidation resistant enhancer and dinonylnaphthalene sulfate as an anti-settling agent.

### CROSS-REFERENCE TO RELATED APPLICATION

This application claims under 35 U.S.C. §119(a) the benefit of Korean Patent Application No. 10-2008-0048814 filed May 26, 2008, the entire contents of which are incorporated herein by reference.

### BACKGROUND

(a) Technical Field

The present invention relates to an antifreeze coolant composition having superior resistance to heat-oxidation, which comprises mercaptobenzothiazole as a heat-oxidation resistant agent, alkylbenzoate as a heat-oxidation resistant enhancer and dinonylnaphthalene sulfate as an anti-settling agent. Antifreeze coolant compositions of the present invention substantially inhibit the production of precipitates of metal salts, while being superior in resistance to heat-oxidation at high temperature.

(b) Background Art

Generally, an antifreeze coolant comprises an antifreezing agent, an anticorrosive agent, a scale inhibitor, an antifoaming agent and dyes. Ethylene glycol, diethylene glycol, triethylene glycol, propylene glycol, dipropylene glycol, tripropylene glycol, etc., are examples of antifreezing agents. Carboxylic acid, phosphoric acid or phosphates, silicates, nitric acid or nitrites, amines, boric acid or borates, benzotriazole, tolyltriazole, mercaptobenzothiazole, etc., are examples of anticorrosive agents.

Commercially available antifreeze coolant generally has to be changed at an interval of about every 2 years. An operation interval longer than 2 years may cause corrosion of metal materials in a cooling device. Various additives have been studied and developed in an effort to develop an antifreeze coolant that is durable for a long period of time. Accordingly, research has been focused on the modification of the conventional anticorrosive agent and not on the development of novel additives.

Commercially available antifreeze liquid or antifreeze coolant compositions disclosed in patents or applications comprises azoles or/and thiazoles to prevent the corrosion of copper-based and brass-based materials. Examples of such patents or applications include Korean patent Nos. 10-2005-0039462 and 10-2007-0062066, Japanese patent application publication Nos. 8-085782 and 1-306492, U.S. Pat. No. 4,584,119 and U.S. patent application publication No. 2006-033077, incorporated by reference in their entireties herein.

Antifreeze coolants comprising azoles or thiazoles as an anticorrosive agent show inferior stability at high temperature, thus causing precipitation of metal due to heat-oxidation. Accordingly, in relevant industries, in particular in the automobile industry, there has been an urgent need for the development of an improved antifreeze coolant that can prevent metal oxidation at high temperature.

The above information disclosed in this Background section is only for enhancement of understanding of the background of the invention and therefore it may contain information that does not form the prior art that is already known in this country to a person of ordinary skill in the art.

### SUMMARY

In one aspect, the present invention is directed to an antifreeze coolant composition where mercaptobenzothiazole is used as a heat-oxidation resistant agent.

In preferred embodiments, the present invention provides an antifreeze coolant composition with considerable thermal stability and anticorrosive property, which preferably comprises the following ingredients.

The present invention provides an antifreeze coolant composition with considerable resistance to heat-oxidation, which preferably comprises mercaptobenzothiazole, alkylbenzoate and dinonylnaphthalene sulfate.

Conventionally, a metal material used for manufacture of cooling devices is easily heat-oxidized by a pyrogenetic engine, thus producing precipitates of metal salts and lowering anticorrosive property. In preferred embodiments, an antifreeze coolant composition of the present invention decreases the production of precipitates of metal salts and shows considerable resistance to heat-oxidation at high temperature, thereby decreasing the use of anticorrosive agent.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a photograph showing remaining precipitates in a tube of a radiator as described in Test Example 3, where an antifreeze liquid of Comparative Example 5 was used.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

As described herein, the present invention includes an antifreeze coolant composition preferably comprising a heat-oxidation resistant agent; a heat-oxidation resistant enhancer and an anti-settling agent.

In preferred embodiments, the heat-oxidation resistant agent is mercaptobenzothiazole. In other preferred embodiments, the heat-oxidation resistant enhancer is alkylbenzoate. In further preferred embodiments, the anti-settling agent is dinonylnaphthalene sulfate.

The invention can also feature a motor vehicle comprising the antifreeze coolant composition as described herein.

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

As described herein, the present invention relates to an antifreeze coolant composition preferably comprising mercaptobenzothiazole as a suitable heat-oxidation resistant agent. Mercaptobenzothiazole has been used in conventional antifreeze coolant compositions as an anticorrosive agent. In preferred embodiments, antifreeze coolant compositions of the invention as described herein preferably comprise dinonylnaphthalene sulfate as a suitable anti-settling agent and alkylbenzoate that suitably prevents heat-oxidation preferably when used in combination with mercaptobenzothiazole and dinonylnaphthalene sulfate.

Described herein is an exemplary antifreeze coolant composition of the present invention.

In preferred embodiments, antifreeze coolant compositions with considerable resistance to heat-oxidation according to the present invention preferably comprise a suitable antifreezing agent, mercaptobenzothiazole, dinonylnaphthalene sulfate, and alkylbenzoate, and preferably may further comprise at least one ingredient selected from, but not limited to, the group consisting of benzoate, azole compounds, phosphoric acid and phosphate compounds.

Described herein are antifreeze coolant compositions according to preferred embodiments of the present invention, preferably based on the content of the ingredients.

In certain preferred embodiments, antifreeze coolant compositions of the present invention preferably comprise 85-98 wt % of an antifreezing agent, 0.3-3 wt % of mercaptobenzothiazole, 0.01-2 wt % of dinonylnaphthalene sulfate, 0.1-10 wt % of alkylbenzoate, 0.1-6 wt % of benzoate, 0.1-1.0 wt % of azole compound and 0.1-2.0 wt % of phosphoric acid or phosphate compound.

Preferably, as an ingredient of a composition herein, the antifreezing agent suitably prevents the freezing of an engine and the damage due to the freezing. Suitable examples of the antifreezing agent include, but are not limited to, ethylene glycol, diethylene glycol, triethylene glycol, propylene glycol, dipropylene glycol, tripropylene glycol and a mixture thereof. In preferred embodiments, the antifreezing agent is preferably used in the amount of 85-98 wt % relative to the total weight of the antifreeze coolant composition. When the amount is less than 85 wt %, a cooling effect can be suitably insufficient and overheating may be observed in the summer, or in tropical regions, due to lowered boiling point. In other embodiments, when the amount is higher than 98 wt %, anticorrosion can be suitably insufficient because relative amounts of other additives are lowered.

In certain embodiments, as an ingredient of a composition herein, the mercaptobenzothiazole is preferably generally used as an anticorrosive agent for copper or brass material. However, in preferred embodiments of the invention as described herein, the mercaptobenzothiazole prevents the heat-oxidation, and is used in the amount of 0.3-3 wt %, preferably 0.3-1 wt %, relative to the total amount of antifreeze coolant composition. When the amount is less than 0.3 wt %, the resistance to heat-oxidation can be suitably insufficient. When the amount is higher than 3 wt %, it can suitably produce a contrary effect on resistance to heat-oxidation due to the discoloration of copper or brass, and a suitably lowered stability of antifreeze coolant

In other embodiments of the invention, as a preferred ingredient of a composition described herein, the dinonylnaphthalene sulfate suitably prevents the precipitation of metal salts, which is caused by the binding between metal ions in antifreeze coolant, which are generated by metal corrosion and the ingredients in antifreeze coolant. In further preferred embodiments, the dinonylnaphthalene sulfate also suitably inhibits the corrosion of iron-based materials. In exemplary embodiments, the dinonylnaphthalene sulfate is used in the amount of 0.01-2 wt %, preferably 0.01-1 wt % relative to the total amount of antifreeze coolant composition. According to embodiments of the invention, when the amount is less than 0.01 wt %, the anticorrosive effect can be suitably insufficient. According to other embodiments, when the amount is higher than 2 wt %, the dissolvability of antifreeze coolant suitably decreases, thus lowering the stability of antifreeze coolant, and the corrosion of iron-based materials can also be suitably accelerated.

Preferably, as an ingredient of a composition as described herein, the alkylbenzoate synergistically increases the resistance to heat-oxidation and prevents the corrosion of iron-based materials, preferably when used in combination with mercaptobenzothiazole and dinonylnaphthalene sulfate. In preferred embodiments, the alkyl group in the alkylbenzoate is a linear or branched C₁-C₅, preferably a C₂-C₄, alkyl group. Suitable examples of the alkylbenzoate include, but are not limited to, ethylbenzoate, propylbenzoate, butylbenzoate, pentylbenzoate and a mixture thereof. In certain exemplary embodiments, the alkylbenzoate is used in the amount of 0.1-10 wt %, preferably 0.1-6 wt %, relative to the total amount of antifreeze coolant composition. When the amount is less than 0.1 wt %, the resistance of heat-oxidation can be suitably insufficient. When the amount is higher than 10 wt %, the production of precipitates in antifreeze coolant can suitably increase.

Preferably, as an ingredient of a composition herein, the benzoate can be selected from the group consisting of, but not limited to, lithium benzoate, potassium benzoate, sodium benzoate and a mixture thereof, and suitably prevents the corrosion of aluminum-based or iron-based materials. Preferably, the benzoate is used in the amount of 0.1-6 wt %, preferably 0.5-4 wt % relative to the total amount of antifreeze coolant composition. In preferred embodiments, when the amount is less than 0.1 wt %, the anticorrosive effect on aluminum materials can be suitably insufficient. In other embodiments, when the amount is higher than 6 wt %, economical efficiency can be suitably lowered due to the excessive use of benzoate.

In preferred embodiments, the azole compound is used as an anticorrosive agent for copper or brass materials. Preferred examples of the azole compound include, but are not limited to, tolyltriazole, benzotriazole, 2-naphthotriazole, 4-nitrobenzotriazole, 4-phenyl-1,2,3-triazole, a derivative thereof and a mixture thereof. Preferably, the azole compound is used in the amount of 0.1-1 wt % relative to the total amount of antifreeze coolant composition. In certain embodiments, when the amount is less than 0.1 wt %, the anticorrosive activity on copper or brass materials can be lowered. In other embodiments, when the amount is higher than 1 wt %, the stability of antifreeze coolant can suitably decrease, thus causing the corrosion of iron-based materials.

In other embodiments, the phosphoric acid or phosphate compound suitably prevents the corrosion of aluminum-based or iron-based materials. Preferred examples of the phosphate compounds include, but are not limited to, orthophosphoric acid, potassium phosphate, dibasic potassium phosphate, monobasic potassium phosphate, sodium phosphate, dibasic sodium phosphate, monobasic sodium phosphate and a mixture there. The phosphoric acid or phosphate compound preferably is used in the amount of 0.1-2 wt % relative to the total amount of antifreeze coolant composition. In certain exemplary embodiments, when the amount is less than 0.1 wt %, the discoloration of aluminum-based materials can occur and the anticorrosive activity can be suitably insufficient. In other exemplary embodiments, when the amount used exceeds 2 wt %, the stability of antifreeze coolant can suitably decrease, thus causing the precipitation of metal salts.

In other embodiments of the invention as described herein, an antifreeze coolant composition with considerable resistance to heat-oxidation of the present invention may further comprise ion-exchanged water for suitably dissolving anticorrosive agent in the amount of 0.5-5 wt % relative to the total amount of antifreeze coolant composition. In one embodiments, when the amount is less than 0.5 wt %, the desired effect may not be sufficient. In other embodiments, when the amount is higher than 5 wt %, the melting point of the antifreeze coolant suitably increases, while the boiling point of the antifreeze coolant suitably decreases.

In other embodiments, the antifreeze coolant composition of the present invention can further preferably comprise potassium hydroxide, sodium hydroxide or a mixture thereof as a pH buffer, thereby adjusting pH to 7-9. The pH buffer is preferably used in the amount of 0.1-4 wt %, preferably 0.1-2 wt % relative to the total amount of antifreeze coolant composition. In certain embodiments, when the amount is less than 0.1 wt %, the pH buffering activity can be suitably insufficient. In other embodiments, when the amount is higher than 4 wt %, the corrosion of aluminum-based or iron-based materials can be suitably accelerated. Preferably, when used as an antifreeze coolant for cooling the engines of vehicles, particularly automobiles, the aforementioned antifreeze coolant composition with considerable resistance to heat-oxidation of the present invention as described herein can suitably increase the change interval and suitably improve the durability of cooling devices, and accordingly the invention as described herein may provide economical advantages.

### EXAMPLES

The following examples illustrate the invention and are not intended to limit the same.

### Examples 1-6

### Preparation of an Antifreeze Liquid

Antifreeze coolant was prepared by heating a mixture comprising the ingredients shown in Table 1 at about 45° C. and completely dissolving the ingredients.

TABLE 1

| | | | Examples | | | | | |
|---|---|---|---|---|---|---|---|---|
| Ingredients (wt %) | | | 1 | 2 | 3 | 4 | 5 | 6 |
| Antifreezing agent | | Ethylene glycol | 90.0 | 89.2 | 90.4 | 89.0 | 89.1 | 94 |
| Heat-oxidation resistant | | Mercaptobenzothiazole | 0.3 | 0.6 | 0.8 | 1.0 | 0.5 | 0.8 |
| agent | | | | | | | | |
| Anti-settling agent | | Dinonylnaphthalene | 0.1 | 0.5 | 0.6 | 0.2 | 0.7 | 0.2 |
| | | sulfate | | | | | | |
| Heat-oxidation resistant | | Butylbenzoate | 1.5 | 2.0 | 1.0 | 1.4 | 1.2 | 2.0 |
| enhancer | | | | | | | | |
| Anticorrosive | Benzoate | Sodium benzoate | 2.0 | 3.0 | 2.6 | 3.5 | 3.0 | 0.5 |
| agent | Azole | Benzotriazole | 0.3 | 0.15 | 0.2 | — | 0.3 | 0.2 |
| | compound | Tolyltriazole | — | 0.15 | — | 0.2 | 0.1 | — |

| | | | | | | |
|---|---|---|---|---|---|---|
| Phosphoric acid | 1.0 | 0.6 | 0.9 | 0.7 | 1.2 | 0.3 |

| | | | | | | | |
|---|---|---|---|---|---|---|---|
| Ion-exchanged water | Distilled water | 3.0 | 2.5 | 2.5 | 2.5 | 2.5 | 1.0 |
| pH buffer | Sodium hydroxide | — | 1.3 | — | 1.5 | — | 1.0 |
| | Potassium hydroxide | 1.8 | — | 1.0 | — | 1.4 | — |

1) Ethylene glycol: Samsung Total (monoethylene glycol)
2) Mercaptobenzothiazole: Junsei Chemical Co., Ltd. (2-mercaptobenzothiazole)
3) Dinonylnaphthalene sulfate: Synthesized
4) Butylbenzoate: Junsei Chemical Co., Ltd.
5) Sodium benzoate: DSM
6) Benzotriazole: PMC
7) Tolyltriazole: PMC

### Comparative Examples 1-7

Antifreeze coolant was prepared heating a mixture comprising the ingredients shown in Table 2 at about 45° C. and completely dissolving the ingredients.

TABLE 2

| | | | Comparative Examples | | | | | | |
|---|---|---|---|---|---|---|---|---|---|
| Ingredients (wt %) | | | 1 | 2 | 3 | 4 | 5 | 6 | 7 |
| Antifreezing agent | | Ethylene glycol | 89.9 | 89.7 | 91 | 90 | 89.95 | 90 | 90 |
| Heat-oxidation resistant | | Mercaptobenzothiazole | 0.1 | 0.3 | — | 0.2 | 0.25 | 4 | 0.1 |
| age nt | | | | | | | | | |
| Anti-settling agent | | Dinonylnaphthalene | 0.1 | 0.5 | 0.6 | — | — | 0.1 | 4 |
| | | sulfate | | | | | | | |
| Heat-oxidation resistant | | Butylbenzoate | 1.5 | — | 1 | 1.4 | — | 1.5 | 1.5 |
| enhancer | | | | | | | | | |
| Anticorrosive | Benzoate | Sodium benzoate | 2 | 3 | 2.6 | 3.5 | 5 | 1 | 1 |
| agent | Azole | Benzotriazole | 0.3 | 0.15 | 0.2 | — | 0.3 | 0.3 | 0.3 |
| | compound | Tolyltriazole | 0.2 | 0.15 | — | 0.2 | 0.1 | — | — |

| | | | | | | | |
|---|---|---|---|---|---|---|---|
| Phosphoric acid | 1 | 0.6 | 0.9 | 0.7 | 1.2 | 1 | 1 |

| | | | | | | | | |
|---|---|---|---|---|---|---|---|---|
| Ion-exchanged water | Distilled water | 3 | 2.5 | 2.5 | 2.5 | 2.5 | 1.1 | 1.1 |
| pH buffer | Sodium hydroxide | — | 1.6 | — | 1.5 | — | — | — |
| | Potassium hydroxide | 1.9 | — | 1.2 | — | 0.8 | 1 | 1 |

| | | | | | | | |
|---|---|---|---|---|---|---|---|
| Heptanoic acid | — | 1.5 | — | — | — | — | — |

### Test Example 1

### Measurement of Precipitation of Antifreeze Liquid

Each antifreeze coolant (50 mL) prepared in Examples and Comparative Examples was placed in a 100 mL beaker, and added with FeCl₃ (100 ppm), thus providing 100 mL of 50 vol % tap water. The tap water was stored under irradiation of indoor lighting and indirect sunlight for 5-20 days, and centrifuged at 2,000 rpm for 10 minutes according to KS M 2069 method, followed by the measurement of the volume of precipitates. The results are present in Table 3.

TABLE 3

| Precipitation | | Test period | | |
|---|---|---|---|---|
| (vol %) | | 5 days | 10 days | 20 days |
| Ex. | 1 | 0.0 | Less than 0.01 | 0.01 |
| | 2 | 0.0 | Less than 0.01 | 0.01 |
| | 3 | 0.0 | Less than 0.01 | 0.02 |
| | 4 | 0.0 | Less than 0.01 | 0.01 |
| | 5 | 0.0 | Less than 0.01 | 0.01 |
| | 6 | 0.0 | Less than 0.01 | 0.02 |
| Comp. | 1 | 0.02 | 0.2 | 0.5 |
| Ex. | 2 | 0.06 | 0.6 | 0.9 |
| | 3 | 0.0 | Less than 0.01 | 0.09 |
| | 4 | 0.08 | 0.6 | 1.2 |
| | 5 | 0.06 | 0.4 | 0.7 |
| | 6 | 0.0 | Less than 0.01 | 0.04 |
| | 7 | 0.0 | 0.02 | 0.13 |

Table 3 shows that antifreeze coolant prepared by using antifreeze coolant composition of the present invention produced negligible amount of precipitates under artificial irradiation because the synergism between ingredients prevents the precipitation.

However, when butylbenzoate or/and dinonylnaphthalene sulfate was absent as in Comparative Examples 1-5, the production of precipitates increased with the time as shown in FIG. 5.

Further, when a heat-oxidation resistant agent (for example, mercaptobenzothiazole) was used in the amount of more than 3 wt % as in Comparative Example 6, the production of precipitates was 2-4 times higher than in Examples 1-6, although less than in Comparative Example 3, where mercaptobenzothiazole was not used. The results described herein show that the stability of antifreeze liquid can decrease, thus increasing the production of precipitates when mercaptobenzothiazole is used in an amount of more than 3 wt %.

Moreover, it was also shown that the stability of antifreeze coolant can decrease, thus increasing the production of precipitates when an anti-settling agent (for example, dinonylnaphthalene sulfate) was used in the amount of more than 2 wt % as in Comparative Example 7.

### Test Example 2

### Measurement of Corrosion of Metal in Contact with Antifreeze Liquid

ASTM corrosive water was prepared by dissolving sodium sulfate (148 mg), sodium chloride (165 mg) and sodium bicarbonate (138 mg) in a distilled water (1 L) according to ASTM D 1384 (Test Method for Corrosion Test for Engine Coolants in Glassware).

The ASTM corrosive water and antifreeze coolant were mixed in a mass cylinder (1000 mL), thus providing ASTM corrosive water containing each antifreeze coolant (30 vol %) as prepared Examples and Comparative Examples. The prepared mixing coolant (750 mL) was placed in a tall beaker, and a set of specimens, a thermometer, a cooling tube and a ventilation tube were attached to the beaker. Antifreeze coolant was maintained at 98±2° C. for 720 hours with a flow of 100 mL/min through the ventilation tube. A change in mass before and after the test was measured by a unit of 0.1 mg for the evaluation of corrosion. The results are presented in Table 4.

TABLE 4

| | | Mass change of metal material | | | | | |
|---|---|---|---|---|---|---|---|
| | | in 30 vol % solution (mg/cm²) | | | | | |
| | | Cast | Cast | | | | |
| | | aluminum | iron | Steel | Brass | Solder | Copper |
| Examples | 1 | −0.03 | −0.04 | +0.01 | +0.04 | −0.05 | +0.07 |
| | 2 | −0.05 | −0.02 | +0.04 | +0.06 | −0.08 | +0.08 |
| | 3 | −0.02 | −0.06 | −0.02 | −0.02 | −0.04 | −0.04 |
| | 4 | −0.04 | −0.05 | −0.01 | −0.03 | −0.06 | −0.02 |
| | 5 | −0.06 | −0.06 | +0.02 | +0.06 | −0.08 | +0.06 |
| | 6 | −0.03 | −0.07 | −0.01 | −0.01 | −0.04 | −0.03 |
| Comparative | 1 | −0.22 | −0.32 | −0.12 | −0.08 | −0.11 | +0.07 |
| Examples | 2 | −0.12 | −0.18 | −0.18 | +0.40 | −0.09 | +0.24 |
| | 3 | −0.28 | −0.4 | −0.16 | −0.18 | −0.07 | −0.25 |
| | 4 | −0.11 | −0.32 | −0.28 | −0.35 | −0.10 | −0.28 |
| | 5 | −0.29 | −0.25 | −0.14 | −0.46 | −0.08 | −0.19 |
| | 6 | −0.32 | −0.36 | −0.29 | +0.32 | −0.02 | +0.25 |
| | 7 | −0.41 | −0.35 | −0.19 | +0.18 | −0.36 | −0.32 |

Table 4 shows that, in comparison to Examples 1-6, corrosion of aluminum-based and iron-based materials increased when mercaptobenzothiazole, butylbenzoate or/and dinonylnaphthalene sulfate was not used. In particular, it the results also show that when the content of mercaptobenzothiazole or dinonylnaphthalene sulfate is out of the range of the present invention, as in Comparative Examples 1, 6 and 7, the stability of antifreeze coolant decreases, thus increasing the precipitation of metal.

### Test Example 3

### Measurement of Circular Corrosion

ASTM corrosive water containing 30 vol % of antifreeze coolant was prepared as described in Test Example 2.

Three sets of specimens 3 were loaded into a test device equipped with a radiator, a heater core and a water pump, and mixing coolant was introduced into the device. After the circulation at 98±2° C. and 60 L/min for 2,000 hours, the parts were dissembled for analysis of the surface appearance. Specimens were weighed in the unit of 0.1 mg, and the results are presented in Table 5.

TABLE 5

| | | Mass change of metal material | | | | | | |
|---|---|---|---|---|---|---|---|---|
| | | in 30 vol % solution (mg/cm²) | | | | | | |
| | | | | | | | | Appearance of |
| | | Cast | Cast | | | | | parts and |
| | | aluminum | iron | Steel | Brass | Solder | Copper | specimens |
| Examples | 1 | −0.08 | −0.06 | −0.04 | −0.08 | −0.06 | −0.07 | No change |
| | 2 | −0.10 | −0.05 | −0.03 | −0.11 | −0.05 | −0.14 | No change |
| | 3 | −0.12 | −0.07 | −0.05 | −0.09 | −0.08 | −0.09 | No change |
| | 4 | −0.12 | −0.04 | −0.03 | −0.06 | −0.07 | −0.16 | No change |
| | 5 | −0.09 | −0.08 | −0.06 | −0.09 | −0.08 | −0.06 | No change |
| | 6 | −0.06 | −0.05 | −0.04 | −0.09 | −0.08 | −0.10 | No change |
| Comparative | 1 | −0.36 | −0.46 | −0.16 | −0.16 | −0.09 | −0.38 | (Localized) |
| Examples | 2 | −0.46 | −0.38 | −0.14 | −0.41 | −0.40 | −0.42 | corrosion in a |
| | 3 | −0.40 | −0.57 | −0.16 | −0.36 | −0.08 | −0.16 | tube (aluminum, |
| | 4 | −0.58 | −0.51 | −0.18 | −0.48 | −0.3 | −0.24 | cast iron and |
| | 5 | −0.14 | −0.42 | −0.20 | −0.39 | −0.40 | −0.28 | steel) and |
| | 6 | −0.38 | −0.36 | −0.32 | +0.35 | −0.06 | +0.31 | precipitation |
| | 7 | −0.43 | −0.39 | −0.33 | −0.36 | −0.42 | −0.38 | |

Table 5 shows that Examples 1-6 caused negligible amount of corrosion in metal parts and specimens, while general or localized corrosion was observed in Comparative Examples 1-7, causing considerable difference in weight of aluminum and cast iron specimens.

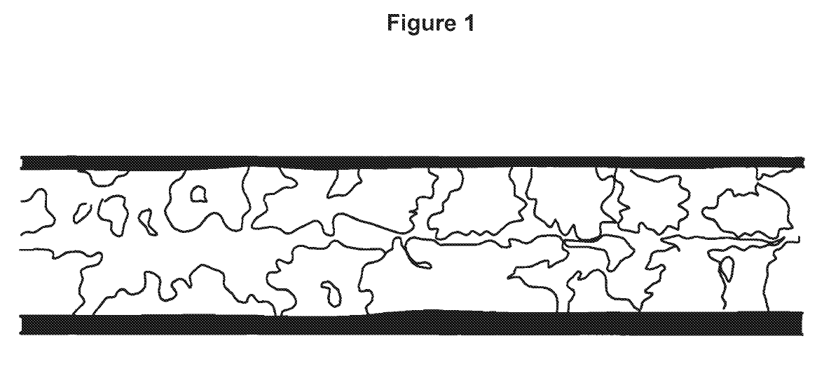

Further, it was also ascertained that Examples 1-6 caused negligible amount of precipitation, while precipitation on the inner surface of the radiator was observed in Comparative Examples 1-7. FIG. 1 shows the precipitation attached on the inner surface of the radiator in Comparative Example 5.

### Test Example 4

### Measurement of Resistance to Heat-Oxidation

For accelerating heat-oxidation, a heat-oxidation accelerator was placed in the tall beaker, and stirred at 1,300 rpm for 200 hours.

ASTM corrosive water prepared in Test Example 1 was added into the tall beaker, and mixed with 30 vol % of antifreeze coolant. Corrosion of metal was measured as described in Test Example 2 at 98±2° C. after 336 hours, and the results are presented in Table 6.

TABLE 6

| | | Mass change of metal material | | | | | | |
|---|---|---|---|---|---|---|---|---|
| | | in 30 vol % solution (mg/cm²) | | | | | | |
| | | | | | | | | Change in |
| | | Cast | Cast | | | | | corrosive |
| | | aluminum | iron | Steel | Brass | Solder | Copper | water |
| Examples | 1 | −0.09 | −0.10 | −0.06 | −0.08 | −0.09 | −0.10 | No change |
| | 2 | −0.10 | −0.09 | −0.07 | −0.07 | −0.08 | −0.12 | |
| | 3 | −0.08 | −0.07 | −0.05 | −0.07 | −0.08 | −0.14 | |
| | 4 | −0.12 | −0.08 | −0.06 | −0.06 | −0.10 | −0.09 | |
| | 5 | −0.07 | −0.10 | −0.06 | −0.10 | −0.11 | −0.10 | |
| | 6 | −0.09 | −0.11 | −0.05 | −0.07 | −0.08 | −0.10 | |
| Comparative | 1 | Localized | Localized | Corrosion | −0.78 | −0.28 | −0.62 | Significant |
| Examples | | corrosion | corrosion | | | | | precipitation |
| | 2 | Corrosion | Corrosion | Localized | −0.54 | −0.29 | −0.70 | |
| | | | | corrosion | | | | |
| | 3 | Corrosion | Localized | Localized | −0.62 | −0.30 | −0.74 | |
| | | | corrosion | corrosion | | | | |
| | 4 | Corrosion | Corrosion | Localized | −0.53 | −0.21 | −0.68 | |
| | | | | corrosion | | | | |
| | 5 | Corrosion | Localized | Localized | −0.42 | −0.26 | −0.54 | |
| | | | corrosion | corrosion | | | | |
| | 6 | Localized | Localized | Localized | +0.39 | −0.07 | +0.41 | |
| | | corrosion | corrosion | corrosion | | | | |
| | 7 | Localized | Corrosion | Localized | −0.32 | −0.41 | −0.37 | |
| | | corrosion | | corrosion | | | | |

Table 6 shows that Examples 1-6 produced negligible amount of metal corrosion and precipitation, while considerable corrosion, particularly of aluminum, cast iron and steel was observed in Comparative Examples 1-7. Higher degree of corrosion of brass, lead and copper was also observed than in Examples.

The results of Comparative Examples 1 and 6 show that, when the content of a heat-oxidation resistant agent (mercaptobenzothiazole) was out of the range of the present invention, the stability of antifreeze liquid decreased, thus increasing corrosion.

Further, when a heat-oxidation resistant enhancer (butylbenzoate) was not used as in Comparative Examples 2 and 5, the corrosion was produced despite the use of a heat-oxidation resistant agent (mercaptobenzothiazole), thus demonstrating the effect of alkylbenzoate in enhancing the prevention of heat-oxidation.

The results and Examples described herein show that the combinational use of mercaptobenzothiazole (a heat-oxidation resistant agent), alkylbenzoate (a heat-oxidation resistant enhancer) and dinonylnaphthalene sulfate (an anti-settling agent) increases resistance to heat-oxidation of antifreeze liquid, and considerably reduces the precipitation by preventing the production of non-soluble metal salts.

Antifreeze coolant of the present invention can maintain the superior cooling effect without the exhaustion of additives, even after long-term operation, thus being applicable in automobile industry.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. An antifreeze coolant composition with superior resistance to heat-oxidation, which comprises mercaptobenzothiazole as a heat-oxidation resistant agent; alkylbenzoate as a heat-oxidation resistant enhancer; and dinonyinaphthalene sulfate as an anti-settling agent.

2. The antifreeze coolant composition of claim 1, which comprises 85-98 wt % of the antifreezing agent, 0.3-3 wt % of mercaptobenzothiazole, 0.01-2 wt % of dinonyinaphthalene sulfate, 0.1-10 wt % of alkylbenzoate, 0.1-6 wt % of benzoate, 0.1-1.0 wt % of an azole compound and 0.1-2.0 wt % of phosphoric acid or phosphate compound.

3. The antifreeze coolant composition of claim 2, wherein the antifreezing agent is selected from the group consisting of ethylene glycol, diethylene glycol, triethylene glycol, propylene glycol, dipropylene glycol, tripropylene glycol and a mixture thereof.

4. The antifreeze coolant composition of claim 2, wherein the azole compound is selected from the group consisting of tolyltriazole, benzotriazole, 2-naphthotriazole, 4-nitrobenzotriazole, 4-phenyl-1,2,3-triazole, a derivative thereof and a mixture thereof.

5. The antifreeze coolant composition of claim 2, wherein the phosphate compound is selected from the group consisting of orthophosphoric acid, potassium phosphate, dibasic potassium phosphate, monobasic potassium phosphate, sodium phosphate, dibasic sodium phosphate, monobasic sodium phosphate and a mixture thereof.

6. The antifreeze coolant composition of claim 1, wherein an alkyl group in the alkylbenzoate is a linear or branched C₂-C₅ alkyl group.

7. The antifreeze coolant composition of claim 1, which further comprises at least one ingredient selected from the group consisting of ion-exchanged water, pH buffer and a mixture thereof.

8. An antifreeze coolant composition comprising:
a heat-oxidation resistant agent;
a heat-oxidation resistant enhancer;
an anti-settling agent.

9. The antifreeze coolant composition of claim 8, wherein the heat-oxidation resistant agent is mercaptobenzothiazole.

10. The antifreeze coolant composition of claim 8, wherein the heat-oxidation resistant enhancer is alkylbenzoate.

11. The antifreeze coolant composition of claim 8, wherein the anti-settling agent is dinonyinaphthalene sulfate.

12. A motor vehicle comprising the antifreeze coolant composition of claim 1.

13. A motor vehicle comprising the antifreeze coolant composition of claim 8.
